(19) United States
(12) Patent Application Publication
(10) Pub. No.: US 2007/0027775 A1
(43) Pub. Date: Feb. 1, 2007

(54) Method for approving electronic payment using the short message service including url call back and system for implementing the same

(76) Inventor: Chang-Yeop Hwang, Seoul (KR)

Correspondence Address: WELSH & KATZ, LTD, 120 S RIVERSIDE PLAZA, 22ND FLOOR, CHICAGO, IL, 60606, US

(21) Appl. No.: 10/575,636

(22) PCT Filed: Oct. 15, 2004
(86) PCT No.: PCT/KR04/02649

§ 371 Date: Apr. 13, 2006

(30) Foreign Application Priority Data
Oct. 16, 2003 (KR) 10-2003-0072209

(51) Int. Cl. G06Q 30/00

(52) U.S. Cl. 705/26

(57) ABSTRACT

Disclosed are method and system for approving electronic payment using SMS including URL callback. Using this method, possession of a mobile terminal is very simply checked for approval of the payment using the mobile terminal. That is to say, if a payment approving server transmits SMS including URL callback to the mobile terminal of a purchaser and the purchaser accesses wireless Internet with the URL callback without inputting any certification number, the payment approving server extracts a mobile terminal number from WAP data packet transmitted from the mobile terminal accessed to the wireless Internet and then checks whether the purchaser possesses the mobile terminal. In addition, a purchaser-identifying authentication code requiring security is not transmitted via the electronic shopping mall server, but directly input to the payment approving server through the wireless Internet, thereby ensuring safe electronic payment.

### TECHNICAL FIELD

The present invention relates to method and system for approving electronic payment, and more particularly to method and system for approving electronic payment using SMS (Short Message Service) including URL callback.

### BACKGROUND ART

Recently, as Internet is propagated nationwide, use of so-called electronic shopping mall, in which a purchaser accesses a web site established on line purchase an article and pay for it, is abruptly increased.

In order to use such an electronic shopping mall, an electronic payment means is essentially used, so various kinds of electronic payment means are now under development. Among various electronic payment means, a payment method using a mobile phone is recently widely used. In this method, a user pays for an article using a mobile phone, and the payment added to a charge of the mobile phone together, and then demanded to be paid.

The payment using a mobile phone (hereinafter, referred to as ‘mobile phone payment’ may be classified into a SMS (Short Message Service) manner and an ARS (Auto Response Service) manner depending on its possession certification method.

In the mobile phone payment using SMS, a purchaser inputs a mobile phone number and a resident registration number in a payment page, and then a payment settlement agency issues random numbers and sends SMS including a specific approval number (5 or 6 digits) to the mobile phone of the purchaser. After that, the purchaser who receives the SMS inputs the specific approval number in the payment page again, and then it is verified that the purchaser possesses the mobile phone and then the payment is completed.

However, the mobile phone payment using SMS is inconvenient in the fact that the purchaser who receives the approval number of 5 or 6 digits from the payment settlement agency should input the approval number with a keyboard.

Meanwhile, the mobile phone payment using ARS uses a method of certificating the fact that a purchaser possesses the mobile phone by making a call to an ARS number. First, if a purchaser inputs a mobile phone number and a resident registration number in the payment page, the payment settlement agency informs the purchaser of an ARS number (9 digits). If the purchaser makes a call to the ARS number with the mobile phone of which phone number is already input in the payment page, the payment settlement agency informs the purchaser of a specific customer number by voice, and then if the purchaser inputs the specific customer number in the payment page, it is verified that the purchaser possesses the mobile phone and then the payment is completed.

However, the mobile phone payment using ARS also has several problems. First, if a purchaser inputs wrong numbers when making a call to the ARS number, the call may be connected to an unexpected person.

In addition, if the purchaser makes a call to the ARS number, the payment settlement agency guides a customer number by voice. However, the purchaser may not input the customer number in the web page due to deficient preparation of a memo, or the purchaser may input wrong customer number since the purchaser hears the voice guidance inaccurately. In these cases, the purchaser should make a call again to the ARS number inconveniently.

In addition, in order to accomplish the mobile phone payment using SMS or ARS, a purchaser should input an authentication code (e.g., resident registration number) for purchaser identification together with the mobile phone number on the payment page provided by the electronic shopping mall. The information input by the purchaser is transmitted to the electronic shopping mall, and the electronic shopping mall transmits the information to the payment settlement agency. Since the electronic shopping mall collects authentication codes for purchaser identification as mentioned above, there is possibility that the information may be flowed out if a manager of the electronic shopping mall has a dishonest mind.

### DISCLOSURE OF INVENTION

The present invention is designed to solve the problems of the prior art, and therefore an object of the invention is to provide method and system for approving electronic payment using SMS including URL callback, which may conveniently conduct possession certification of a mobile terminal by receiving an access of a purchaser to wireless Internet through URL callback when the purchaser makes electronic payment using the mobile terminal.

In addition, another object of the invention is to provide method and system for approving electronic payment using SMS, which is capable of conducting safe payment since a payment approving server directly receives authentication code for purchaser identification on wireless Internet from a purchaser when the purchaser desires electronic payment using a mobile terminal.

In order to accomplish the above object, the present invention provides a method for approving electronic payment in an electronic shopping mall with the use of a purchaser mobile terminal, conducted by a mobile communication service provider server that operates a mobile communication subscriber database and a payment approving server that is associated with an electronic shopping mall server through a communication network and supports WAP service, the method comprising: (a) receiving product transaction information including product information and price information of a product to be purchased together with a mobile terminal number of the purchaser and an authentication code for identifying the purchaser from a purchaser terminal that accesses the electronic shopping mall server; (b) requesting payment certification with transmitting payment certification information including the mobile terminal number and the purchaser-identifying authentication code to the mobile communication service provider server, and then waiting for a response; (c) transmitting SMS (Short Message Service) including URL callback for linking WAP access of the payment approving server to the purchaser mobile terminal through the mobile communication service provider server when the mobile communication service provider server transmits a certification success code as a result of inquiring the mobile communication subscriber database with the use of the payment certification information; and (d) approving the payment under the condition that a mobile terminal transmitted in connection to WAP is identical to the mobile terminal number received in the electronic shopping mall server when the purchaser mobile terminal accesses WAP with the use of the URL callback.

In another aspect of the invention, there is also provided a method for approving electronic payment in an electronic shopping mall with the use of a purchaser mobile terminal, conducted by a mobile communication service provider server that operates a mobile communication subscriber database and a payment approving server that is associated with an electronic shopping mall server through a communication network and supports WAP service, the method comprising: (a) receiving product transaction information including product information and price information of a product to be purchased together with a mobile terminal number of the purchaser from a purchaser terminal that accesses the electronic shopping mall server; (b) transmitting SMS including URL callback for linking WAP access of the payment approving server to the purchaser mobile terminal through the mobile communication service provider server; (c) receiving a purchaser-identifying authentication code from the purchaser mobile terminal under the condition that a mobile terminal number transmitted in connection to WAP is identical to the mobile terminal number received in the electronic shopping mall server when the purchaser mobile terminal accesses WAP with the use of the URL callback; (d) requesting payment certification with transmitting payment certification information including the mobile terminal number and the purchaser-identifying authentication code to the mobile communication service provider server, and then waiting for a response; and (e) approving the payment when the mobile communication service provider server transmits a certification success code as a result of inquiring the mobile communication subscriber database with the use of the payment certification information.

In still another aspect of the invention, there is also provided a system for approving electronic payment using SMS including URL callback, which includes a payment approving server for receiving a request for electronic payment from a purchaser terminal that accesses an electronic shopping mall server and then approving the electronic payment in association with a mobile communication service provider server that operates a mobile communication subscriber database, and also supporting WAP service, wherein the payment approving server executes: receiving product transaction information including product information and price information of a product to be purchased together with a mobile terminal number of the purchaser and an authentication code for identifying the purchaser from a purchaser terminal that accesses the electronic shopping mall server; requesting payment certification with transmitting payment certification information including the mobile terminal number and the purchaser-identifying authentication code to the mobile communication service provider server, and then waiting for a response; transmitting SMS including URL callback for linking WAP access of the payment approving server to the purchaser mobile terminal through the mobile communication service provider server when the mobile communication service provider server transmits a certification success code as a result of inquiring the mobile communication subscriber database with the use of the payment certification information; and approving the payment under the condition that a mobile terminal transmitted in connection to WAP is identical to the mobile terminal number received in the electronic shopping mall server when the purchaser mobile terminal accesses WAP with the use of the URL callback.

In further another aspect of the invention, there is also provided a system for approving electronic payment using SMS including URL callback, which includes a payment approving server for receiving a request for electronic payment from a purchaser terminal that accesses an electronic shopping mall server and then approving the electronic payment in association with a mobile communication service provider server that operates a mobile communication subscriber database, and also supporting WAP service, wherein the payment approving server executes: receiving product transaction information including product information and price information of a product to be purchased together with a mobile terminal number of the purchaser from a purchaser terminal that accesses the electronic shopping mall server; transmitting SMS including URL callback for linking WAP access of the payment approving server to the purchaser mobile terminal through the mobile communication service provider server; receiving a purchaser-identifying authentication code from the purchaser mobile terminal under the condition that a mobile terminal number transmitted in connection to WAP is identical to the mobile terminal number received in the electronic shopping mall server when the purchaser mobile terminal accesses WAP with the use of the URL callback; requesting payment certification with transmitting payment certification information including the mobile terminal number and the purchaser-identifying authentication code to the mobile communication service provider server, and then waiting for a response; and approving the payment when the mobile communication service provider server transmits a certification success code as a result of inquiring the mobile communication subscriber database with the use of the payment certification information.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view showing an electronic payment approving system using SMS including URL callback according to an embodiment of the present invention;

FIGS. 2a and 2b are flowcharts for illustrating an electronic payment approving method using SMS including URL callback according to an embodiment of the present invention;

FIG. 3 is a time-based diagram for illustrating operation of each network component in the electronic payment approving method shown in FIGS. 2a and 2b;

FIGS. 4a and 4b are flowcharts for illustrating an electronic payment approving method using SMS including URL callback according to another embodiment of the present invention; and

FIG. 5 is a time-based diagram for illustrating operation of each network component in the electronic payment approving method shown in FIGS. 4a and 4b.

### BEST MODES FOR CARRYING OUT THE INVENTION

Hereinafter, preferred embodiments of the present invention will be described in detail with reference to the accompanying drawings.

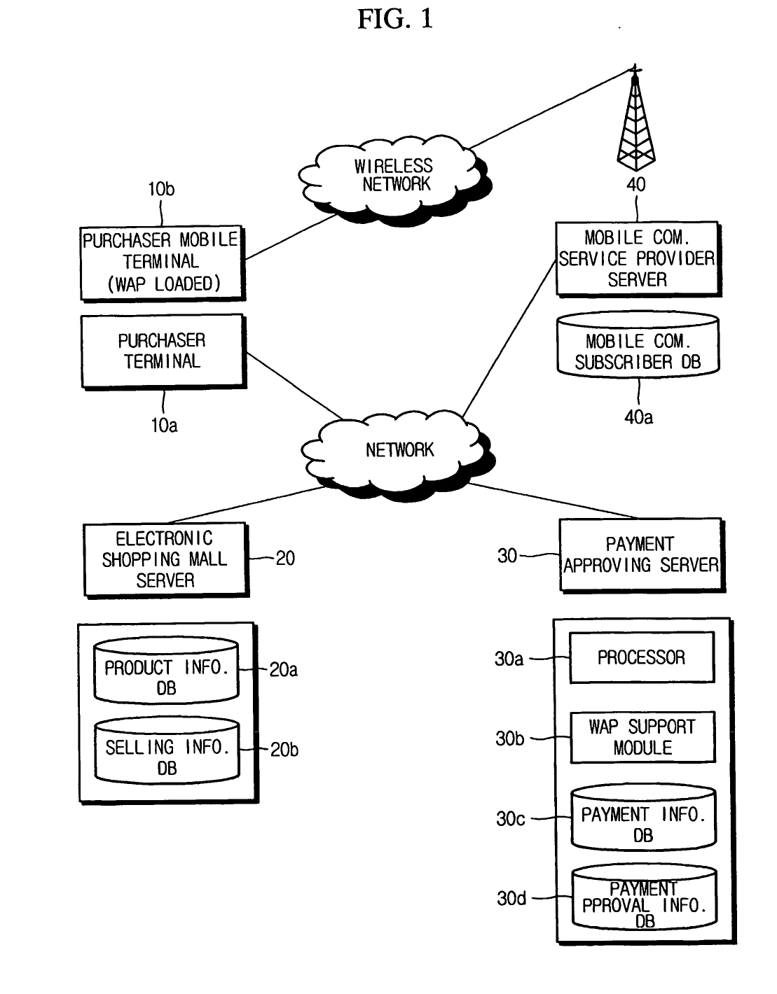

FIG. 1 is a schematic view showing a system for implementing an electronic payment approving method using SMS (Short Message Service) including URL callback according to the present invention.

Referring to FIG. 1, the system for approving electronic payment using SMS including URL callback includes a purchaser terminal 10a, a purchaser mobile terminal 10b, an electronic shopping mall server 20, a payment approving server 30, and a mobile communication service provider server 40.

The payment approving server 30 is connected to the purchaser terminal 10a, the electronic shopping mall server 20 and the mobile communication service provider server 40 through a communication network to ensure communication among them. In addition, the payment approving server 30 supports a wireless WAP service so as to be connected to the purchaser mobile terminal 10b through a wireless communication network. The electronic shopping mall server 20 provides an electronic commerce site on line, and a purchaser accesses the electronic shopping mall server 20 through the communication network with the use of the purchaser terminal 10a and then purchases a product by means of electronic payment according to the present invention.

In the present invention, the communication network is an Internet communication network using TCT/IP (Transmission Control Protocol/Internet Protocol) for worldwide communication, which includes LAN, WAN, Intranet and other similar internal networks. The communication network should be also understood to include wireless communication network capable of transmitting voice, image and data with a portable mobile terminal such as a mobile phone, a cellular phone and a hand-held phone adopting CDMA (Code Division Multiple Access), TDMA (Time Division Multiple Access) or IMT2000.

The purchaser terminal 10a is a terminal used for inputting information required for electronic payment using the mobile terminal 10b to the electronic shopping mall server 20 after a purchaser accesses the electronic shopping mall server 20, searches a product and requests a purchase of the product. The purchaser terminal 10a should be provided with an input device and an output device, and capable of accessing the electronic shopping mall server 20 through the communication network. In addition, an Internet browser such as Explorer of Microsoft is preferably loaded on the purchaser terminal 10a for connection to the electronic shopping mall server 20.

The purchaser terminal 10a may be a desktop, a notebook, a palmtop or PDA (Personal Digital Assistant), but not limitedly.

The purchaser mobile terminal 10b is a terminal capable of receiving SMS (Short Message Service) transmitted from the payment approving server 30 and allowing to use wireless Internet service. For this purpose, a wireless Internet browser (e.g., WAP browser) is preferably loaded on the purchaser mobile terminal 10b in order to allow access to the wireless communication network and use of wireless Internet contents.

The mobile terminal 10b should be subscribed as a mobile communication subscriber in the mobile communication service provider server 40 that receives a request of payment from the payment approving server 30 and then certificates the payment.

The purchaser mobile terminal 10b may be representatively a cellular phone, PCS or PDA, but not limitedly. The mobile terminal 10b is generally provided with a keypad as an input device, but it may also have a touch-screen or a voice recognition device.

The electronic shopping mall server 20 establishes an online site to provide product information and conducts electronic payment in association with the payment approving server 30 so that a purchaser may access it and purchase a product through the communication network. The electronic shopping mall server 20 includes a product information database 20a storing product name, product price and so on, and a selling information database 20b storing payment results.

Specifically, in the product information database 20a, product information such as a product name, a product ID code, a product price, a kind of product, a product picture, a product manufacturer, and a total stock is recorded and managed. In case that the electronic shopping mall server 20 sells online contents such as abata or moving pictures, it is possible to store the online contents themselves in the product information database 20a.

In the selling information database 20b, there are recorded and managed a payment-approved price, a payment-approved product information, a payment approval date, a purchaser ID code, an amount of product sold, a product selling date, an address for delivery, a payment approval serial number and so on.

The payment approving server 30 includes a processor 30a for processing an electronic payment approving process according to the present invention, and a WAP support module 30b for allowing the purchaser mobile terminal 10b to access WAP through the wireless communication network and processing WAP data while the electronic payment approving method according to the present invention is executed. As databases, the payment approving server 30 includes a payment information database 30c and a payment approval information database 30d.

The processor 30a executes overall electronic payment processes, such as receiving data required for electronic payment according to the present invention from the electronic shopping mall server 20, conducting certification related to the electronic payment in association with the mobile communication service provider server 40 on the basis of the data, and determining whether or not to approve the electronic payment according to the certification result.

The WAP support module 30b supports so that a purchaser may be provided with WAP service when accessing the payment approving server 30 through the wireless mobile communication network with the use of the mobile terminal 10b. The WAP support module 30b has wireless Internet contents made of WML that is a Markup Language used by WAP protocol. The wireless Internet contents include a WAP page for notifying the product transaction information transmitted from the electronic shopping mall server 20 to the mobile terminal 10b, and a payment information inputting WAP page having fields for inputting a purchaser-identifying authentication code.

In the payment information database 30c, there are recorded and managed a mobile terminal number of the purchaser and a purchaser-identifying authentication code together with the product transaction information including the product information and the payment price information received when a request for payment approval is received from the electronic shopping mall server 20.

In addition, the payment approval information database 30d stores information about electronic payment approved by the payment approving server 30. More specifically, in the payment approval information database 30d, there are recorded and managed a mobile terminal number, a payment-approved product information, a member store code of the electronic shopping mall server 20, a payment approval date, a payment approval serial number, and a payment-approved price and so on.

The mobile communication service provider server 40 is a server of a mobile communication service provider that provides mobile communication service to the general and operates a mobile communication subscriber database 40a. The mobile communication service provider server 40 conducts payment certification in association with the payment approving server 30, receives a product price from the purchaser by means of a mobile communication charge bill, and settles the account to the payment approving server 30.

In the mobile communication subscriber database 40a, there are recorded a mobile terminal number of the subscriber, a purchaser-identifying authentication code, subscriber information such as an ID code of the subscriber and corporation/minor, a mobile communication charge, a charge payment state (paid/delayed/bad credit), a given payment limit capable of being settled by the mobile terminal, a total payment accumulated until now, a mobile terminal state (normal/suspended/lost/terminated), a subscribed payment product (minor payment product/prepaying product), and a secret number registered by the subscriber to the mobile communication service provider server.

The mobile communication service provider server 40 inquires the mobile communication subscriber database 40a with the use of the payment certification information such as the mobile terminal number, the purchaser-identifying authentication code and the product price transmitted from the payment approving server 30 to determine whether the mobile terminal number is recorded in the mobile communication subscriber database 40a, whether a mobile communication charge of the purchaser is delayed, and whether the mobile terminal is in a suspended or terminated state. In addition, the mobile communication service provider server 40 also determines whether the purchaser-identifying authentication code input by the purchaser is identical to the purchaser-identifying authentication code recorded in the mobile communication subscriber database 40a, and whether the sum of the accumulated total payment and the product price is not exceeding the payment limit.

The payment approving server 30 transmits SMS including URL callback for linking WAP access of the payment approving server 30 to the mobile terminal 10b of the purchaser through the mobile communication service provider server 40. In addition, the payment approving server 30 provides the wireless Internet contents of the WAP support module 30b to the purchaser mobile terminal 10b, and compares the mobile terminal number input by the purchaser with a mobile terminal number extracted from WAP data packet transmitted from the mobile terminal 10b through the wireless communication network when the purchaser accesses WAP. In addition, the payment approving server 30 provides a WAP page having a field for inputting the purchaser-identifying authentication code to the purchaser mobile terminal 10b.

The purchaser accesses WAP service of the payment approving server 30 through the wireless communication network with the use of the SMS, and inputs the purchaser-identifying authentication code in the WAP page provided by the WAP support module 30b of the payment approving server 30 with the use of the input device of the mobile terminal 10b.

Now, the method for approving electronic payment using SMS including URL callback according to one embodiment of the present invention is described in more detail.

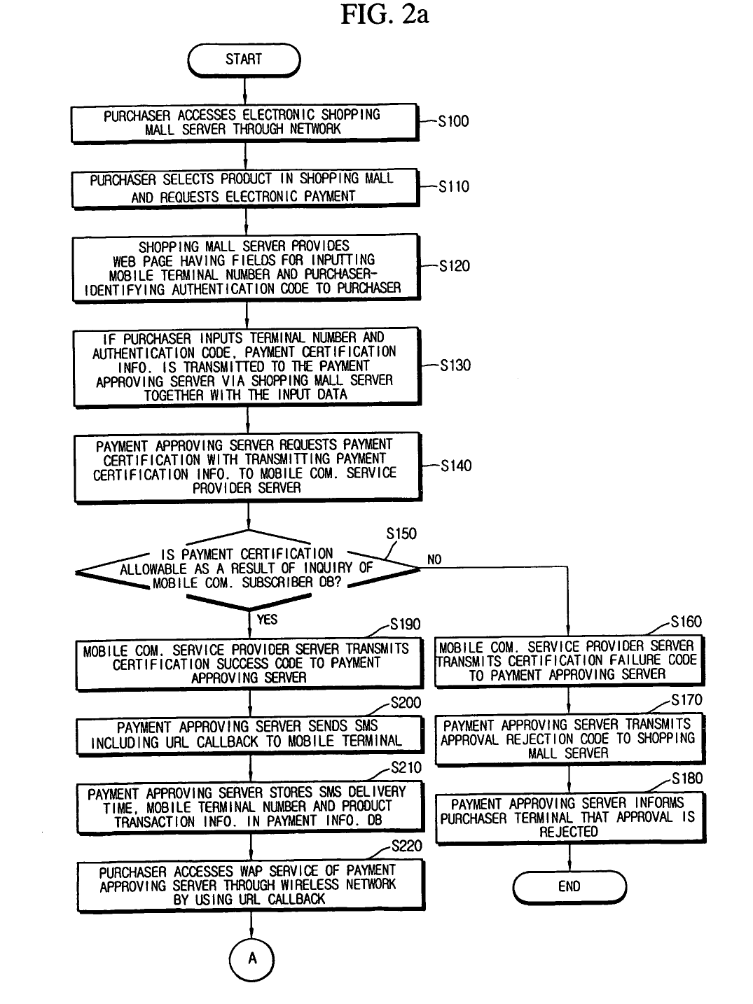

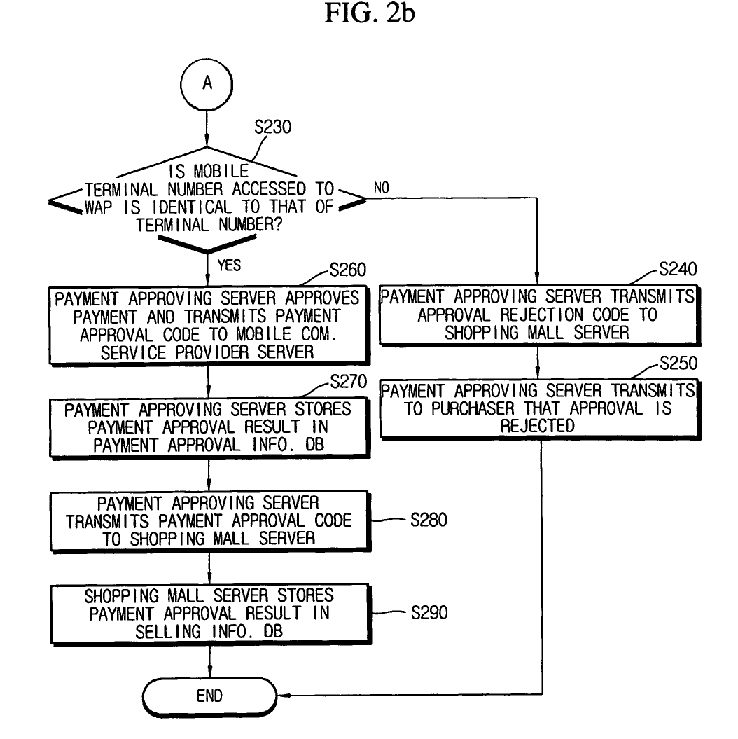

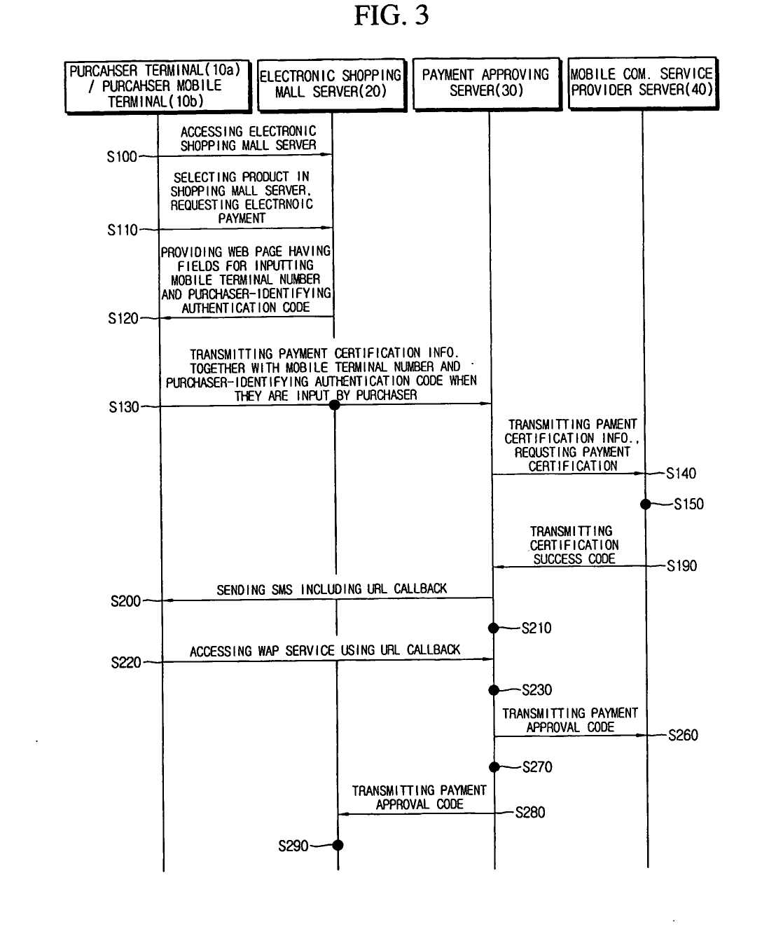

FIGS. 2a and 2b are flowcharts for illustrating the electronic payment approving method using SMS including URL callback, and FIG. 3 is a time-based diagram for illustrating operation of each network component in the electronic payment approving method shown in FIGS. 2a and 2b.

To describe the electronic payment approving method of this embodiment with reference to FIGS. 2a, 2b and 3, a purchaser firstly uses the purchaser terminal 10a to access the electronic shopping mall server 20 through the communication network (S100).

After that, the purchaser searches the product information database 20a in the electronic shopping mall server 20 to select a product to be purchased, and requests electronic payment for the product to the electronic shopping mall server 20 (S10).

Then, the electronic shopping mall server 20 provides a payment certification information input web page (not shown) having fields for input of a phone number of the mobile terminal 10b and a purchaser-identifying authentication code to the purchaser (S120).

The purchaser-identifying authentication code may be a resident registration number of the purchaser or a secret number that the purchaser has registered in the mobile communication service provider server 40. In some cases, the purchaser-identifying authentication code may be a combination of the resident registration code and the secret number.

If the payment certification information input web page (not shown) is provided in the step S120, the purchaser inputs the mobile terminal number and the purchaser-identifying authentication code. Then, the mobile terminal number and the purchaser-identifying authentication code are transmitted to the payment approving server 30 via the electronic shopping mall server 20 (S130). At this time, the product transaction information including product information of the product for which the purchaser requests payment and a member store code of the electronic shopping mall server 20 are preferably transmitted together to the payment approving server 30 (S130).

After the step S130, the payment approving server 30 requests certification of the electronic payment using the mobile terminal with transmitting the payment certification information including the mobile terminal number and the purchaser-identifying authentication code to the mobile communication service provider server 40 (S140).

Then, the mobile communication service provider server 40 certifies the electronic payment by inquiring the mobile communication subscriber database 40a with the use of the payment certification information (S150).

Specifically, the mobile communication service provider server 40 inquires the mobile communication subscriber database 40a to determine whether the mobile terminal number is recorded in the mobile communication subscriber database 40a, whether a mobile communication charge is not delayed, and whether the purchaser mobile terminal is terminated or suspended, and then certifies the payment. In addition, the mobile communication service provider server 40 determines whether the purchaser-identifying authentication code input by the purchaser is identical to that recorded in the mobile communication subscriber database 40a.

When certifying the electronic payment, the mobile communication service provider server 40 may further conduct credit verification by inquiring a credit limit and a balance. In this case, the payment approving server 30 further receives price information from the electronic shopping mall server 20 in the step S130, and then transmits the price information to the mobile communication service provider server 40 in the step S140. Then, the mobile communication service provider server 40 inquires a predetermined payment limit capable of being settled by the mobile terminal and a total payment accumulated until now, which are recorded in the mobile communication subscriber database 40a, in the step S150 to determine whether the sum of the accumulated total payment and the price is not exceeding the payment limit.

If the mobile communication service provider server 40 inquires the mobile communication subscriber database 40a in the S150 and determines that certification for the payment is not allowable (No in S150), the mobile communication service provider server 40 transmits a certification failure code to the payment approving server 30 (S160). The payment approving server 30 receiving the certification failure code then transmits an approval rejection code to the electronic shopping mall server 20 (S170). In addition, the payment approving server 30 preferably transmits to the purchaser terminal 10a that the approval for payment is rejected (S180).

However, if the mobile communication service provider server 40 determines that the certification for the payment is allowable in the step S150 as a result of inquiry to the mobile communication subscriber database 40a (YES in S150), the mobile communication service provider server 40 transmits a certification success code to the payment approving server 30 (S190).

If the certification success code is transmitted, the payment approving server 30 transmits SMS including URL callback to the purchaser mobile terminal 10b via the mobile communication service provider server 40 (S200). Here, the URL callback is an address that ensures direct access to WAP service of the payment approving server 30. The SMS preferably includes a content informing of the product information such as a price.

After the step S200, the payment approving server 30 preferably stores data such as a SMS delivery time and a mobile terminal number in the payment information database 30c (S210).

The purchaser receives the SMS including the URL callback in the mobile terminal 10b, and then accesses WAP service provided by the payment approving server 30 through the wireless communication network by manipulation such as pushing of a call button together with checking the SMS (S220).

If the purchaser accesses WAP in the step S220, the payment approving server 30 checks whether a mobile terminal number of the mobile terminal that accesses the WAP is identical to the mobile terminal number input on the payment certification information input web page by the purchaser in the step S130 (S230). At this time, the mobile terminal number of the mobile terminal accessed to WAP may be extracted from WAP data packet transmitted from the mobile terminal 10b. While checking that the mobile terminal numbers are identical to each other, the payment approving server 30 refers to the mobile terminal number to which the SMS recorded in the payment information database 30c is sent in the S210.

If the mobile terminal number accessed to WAP is not identical to the mobile terminal number input by the purchaser in the step S230 (NO in S230), the payment approving server 30 transmits an approval rejection code to the electronic shopping mall server 20 (S240). In this case, the payment approving server 30 preferably transmits to the purchaser mobile terminal 10b that the approval for the electronic payment is rejected (S250).

However, if the mobile terminal number accessed to WAP is identical to the mobile terminal number input by the purchaser in the step S230 (ES in S230), the payment approving server 30 finally approves the electronic payment and then transmits a payment approval code to the mobile communication service provider server 40 (S260). In addition, the payment approving server 30 preferably stores data such as the payment-approved mobile terminal number, the payment-approved price, the payment-approved product information, the member store code of the electronic shopping mall server 20 and the payment approval date in the payment approval information database 30d (S270).

After the step S260, the payment approving server 30 transmits the payment approval code to the electronic shopping mall server 20 (S280). Then, the electronic shopping mall server 20 preferably stores data such as the payment-approved price, the payment-approved product information and the payment approval date in the selling information database 20b (S290).

After that, the electronic payment using SMS including URL callback according to one embodiment of the present invention is completed.

According to this embodiment, when a purchaser receiving SMS including URL callback just pushes a call button of the mobile terminal 10b, the purchaser accesses WAP service of the payment approving server 30 and is then certified to possess the mobile terminal. Thus, the purchaser may use the electronic payment in a simple and easy way using the mobile terminal.

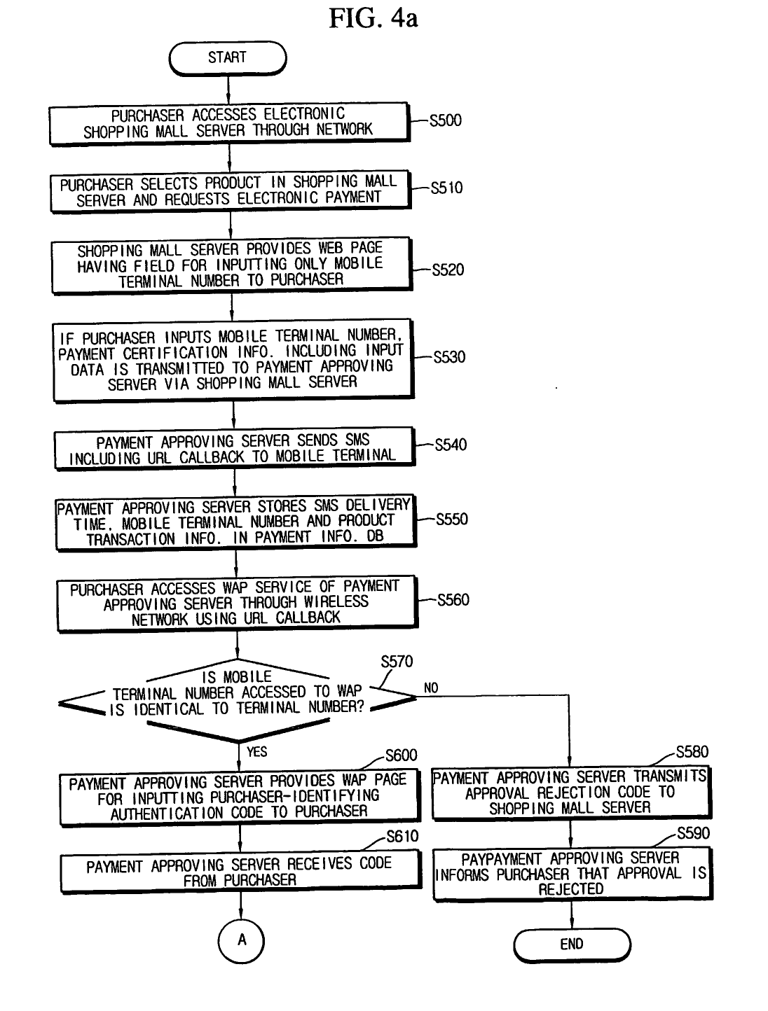

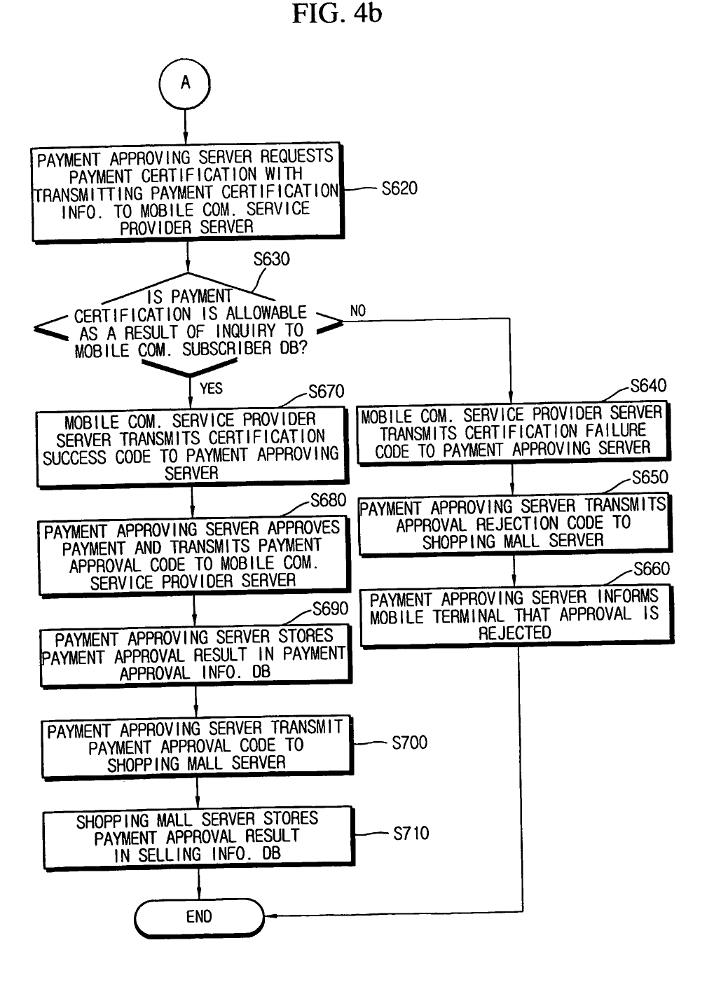

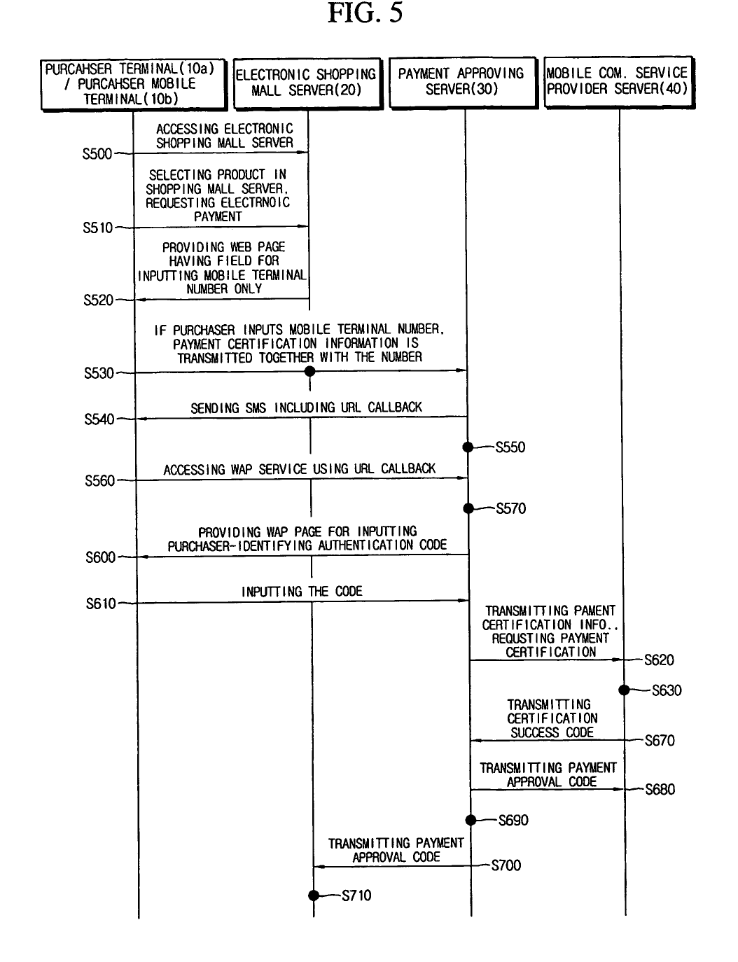

FIGS. 4a and 4b are flowcharts for illustrating an electronic payment approving method using SMS including URL callback according to another embodiment of the present invention, and FIG. 5 is a time-based diagram for illustrating operation of each network component in the electronic payment approving method shown in FIGS. 4a and 4b.

To describe the electronic payment approving method of this embodiment with reference to FIGS. 4a, 4b and 5, a purchaser firstly uses the purchaser terminal 10a to access the electronic shopping mall server 20 through the communication network (S500). After that, the purchaser selects a product to be purchased using the product information database 20a in the electronic shopping mall server 20, and then requests electronic payment for the product to the electronic shopping mall server 20 (S510).

The electronic shopping mall server 20 receiving the electronic payment request provides a payment certification information input web page (not shown) having a field for input of a mobile terminal number to the purchaser (S520). At this time, the payment certification information input web page has only the field for inputting the mobile terminal number, not a field for inputting a purchaser-identifying authentication code. It is because the purchaser-identifying authentication code will be received from the purchaser mobile terminal 10b in the step S610, described later, through the wireless communication terminal.

If the purchaser inputs the mobile terminal number in the payment certification information input web page (not shown), the information is transmitted to the payment approving server 30 via the electronic shopping mall server 20 (S530). At this time, the product transaction information including product information of the product for which the purchaser requests payment and a member store code of the electronic shopping mall server 20 are also transmitted together to the payment approving server 30 (S530).

After the step S530, the payment approving server 30 transmits SMS including URL callback to the purchaser mobile terminal 10b via the mobile communication service provider server 40 (S540).

The URL callback is an address that ensures direct access to the payment approving server 30 supporting the WAP service. After sending the SMS, the payment approving server 30 preferably stores data such as a SMS delivery time and a mobile terminal number in the payment information database 30c (S550).

The purchaser receiving the SMS accesses the WAP service of the payment approving server 30 through the wireless communication network by using the URL callback on the mobile terminal 10b (S560).

If the purchaser accesses WAP in the step S560, the payment approving server 30 checks whether a mobile terminal number of the mobile terminal that accesses the WAP is identical to the mobile terminal number input by the purchaser on the payment certification information input web page in the step S530, like the step S230 (S570). At this time, the mobile terminal number of the mobile terminal accessed to WAP may be extracted from WAP data packet transmitted from the mobile terminal 10b. While checking that the mobile terminal numbers are identical to each other, the payment approving server 30 refers to the mobile terminal number to which the SMS recorded in the payment information database 30c is sent in the S550.

If the mobile terminal number accessed to WAP is not identical to the mobile terminal number input by the purchaser in the step S570 (NO in S570), the payment approving server 30 transmits an approval rejection code to the electronic shopping mall server 20 (S580). In addition, the payment approving server 30 preferably transmits to the purchaser mobile terminal 10b that the approval for the electronic payment is rejected (S590).

However, if the mobile terminal number accessed to WAP is identical to the mobile terminal number input by the purchaser in the step S570 (ES in S570), the payment approving server 30 provides a WAP page (not shown) for input of a purchaser-identifying authentication code, stored in the WAP support module 30b, to the purchaser mobile terminal 10b (S600).

If the purchaser inputs the purchaser-identifying authentication code by pressing a keypad of the mobile terminal 10b or pressing a touch pen onto a touch screen on the WAP page (not shown), the payment approving server 30 receives the data (S610). The purchaser-identifying authentication code, which is input from the purchaser mobile terminal 10b through the wireless communication network differently from the former embodiment, is directly transmitted to the payment approving server 30 without passing through the electronic shopping mall server 20.

After the step S610, the payment approving server 30 requests certification of the electronic payment using the mobile terminal with transmitting the payment certification information including the mobile terminal number and the purchaser-identifying authentication code to the mobile communication service provider server 40 (S620).

Then, the mobile communication service provider server 40 certifies the electronic payment by inquiring the mobile communication subscriber database 40a with the use of the payment certification information (S630).

Specifically, the mobile communication service provider server 40 inquires the mobile communication subscriber database 40a to determine whether the mobile terminal number is recorded in the mobile communication subscriber database 40a, whether a mobile communication charge is not delayed, and whether the purchaser mobile terminal is terminated or suspended, and then certifies the payment. In addition, the mobile communication service provider server 40 also determines whether the purchaser-identifying authentication code input by the purchaser is identical to that recorded in the mobile communication subscriber database 40a.

When certifying the electronic payment, the mobile communication service provider server 40 may further conduct credit verification by inquiring a credit limit and a balance. In this case, the payment approving server 30 further receives price information from the electronic shopping mall server 20 in the step S530, and then transmits the price information to the mobile communication service provider server 40 in the step S630. Then, the mobile communication service provider server 40 inquires a predetermined payment limit capable of being settled by the mobile terminal and a total payment accumulated until now, which are recorded in the mobile communication subscriber database 40a, in the step S620 to determine whether the sum of the accumulated total payment and the price is not exceeding the payment limit.

If the mobile communication service provider server 40 inquires the mobile communication subscriber database 40a in the S630 and determines that certification for the payment is not allowable (No in S630), the mobile communication service provider server 40 transmits a certification failure code to the payment approving server 30 (S640). The payment approving server 30 receiving the certification failure code then transmits an approval rejection code to the electronic shopping mall server 20 (S650). In addition, the payment approving server 30 preferably transmits to the purchaser mobile terminal 10b that the approval for payment is rejected (S660).

However, if the mobile communication service provider server 40 determines that the certification for the payment is allowable in the step S630 as a result of inquiry to the mobile communication subscriber database 40a (YES in S630), the mobile communication service provider server 40 transmits a certification success code to the payment approving server 30 (S670).

If the certification success code is transmitted, the payment approving server 30 finally approves the electronic payment and then transmits a payment approval code to the mobile communication service provider server 40 (S680). In addition, the payment approving server 30 preferably stores data such as the payment-approved mobile terminal number, the payment-approved price, the payment-approved product information, the member store code of the electronic shopping mall server 20 and the payment approval date in the payment approval information database 30d (S690).

After the step S670, the payment approving server 30 also transmits the payment approval code to the electronic shopping mall server 20 (S700). Then, the electronic shopping mall server 20 preferably stores data such as the payment-approved price, the payment-approved product information and the payment approval date in the selling information database 20b (S710).

After that, the electronic payment using SMS including URL callback according to this embodiment of the present invention is completed.

According to this embodiment, a purchaser may conduct electronic payment in an easy and convenient way since the purchaser is certified for possession of a mobile terminal by accessing the wireless Internet using SMS including URL callback and directly inputs the purchaser-identifying authentication code, which requires high level of security, directly to the payment approving server 30 through the wireless communication network that is safer than a wired communication network.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, in one aspect of the invention, the electronic payment may be accomplished using a mobile terminal since possession of the mobile terminal may be checked just by simple manipulation such as pushing a call button with seeing SMS including URL callback.

In another aspect of the invention, the electronic payment may be accomplished in a safe way since the purchaser-identifying authentication code is transmitted through the wireless communication network, which is relatively safer than the case that both of the mobile terminal number and the purchaser-identifying authentication code are transmitted through a wired communication network having weak security.

In still another aspect of the present invention, compared with the conventional case that even purchaser-identifying authentication codes requiring security are collected in the electronic shopping mall server, the purchaser-identifying authentication code is directly transmitted to the payment approving server through the wireless communication network without passing through the electronic shopping mall server in the present invention, so there is no possibility that an operator of the electronic shopping mall server illegally uses the payment information for bad purpose.

1. A method for approving electronic payment in an electronic shopping mall with the use of a purchaser mobile terminal, conducted by a mobile communication service provider server that operates a mobile communication subscriber database and a payment approving server that is associated with an electronic shopping mall server through a communication network and supports WAP service, the method comprising:
(a) receiving product transaction information including product information and price information of a product to be purchased together with a mobile terminal number of the purchaser and an authentication code for identifying the purchaser from a purchaser terminal that accesses the electronic shopping mall server;
(b) requesting payment certification with transmitting payment certification information including the mobile terminal number and the purchaser-identifying authentication code to the mobile communication service provider server, and then waiting for a response;
(c) transmitting SMS (Short Message Service) including URL callback for linking WAP access of the payment approving server to the purchaser mobile terminal through the mobile communication service provider server when the mobile communication service provider server transmits a certification success code as a result of inquiring the mobile communication subscriber database with the use of the payment certification information; and
(d) approving the payment under the condition that a mobile terminal transmitted in connection to WAP is identical to the mobile terminal number received in the electronic shopping mall server when the purchaser mobile terminal accesses WAP with the use of the URL callback.

2. A method for approving electronic payment in an electronic shopping mall with the use of a purchaser mobile terminal, conducted by a mobile communication service provider server that operates a mobile communication subscriber database and a payment approving server that is associated with an electronic shopping mall server through a communication network and supports WAP service, the method comprising:
(a) receiving product transaction information including product information and price information of a product to be purchased together with a mobile terminal number of the purchaser from a purchaser terminal that accesses the electronic shopping mall server;
(b) transmitting SMS including URL callback for linking WAP access of the payment approving server to the purchaser mobile terminal through the mobile communication service provider server;
(c) receiving a purchaser-identifying authentication code from the purchaser mobile terminal under the condition that a mobile terminal number transmitted in connection to WAP is identical to the mobile terminal number received in the electronic shopping mall server when the purchaser mobile terminal accesses WAP with the use of the URL callback;
(d) requesting payment certification with transmitting payment certification information including the mobile terminal number and the purchaser-identifying authentication code to the mobile communication service provider server, and then waiting for a response; and
(e) approving the payment when the mobile communication service provider server transmits a certification success code as a result of inquiring the mobile communication subscriber database with the use of the payment certification information.

3. The method for approving electronic payment according to claim 1 wherein the purchaser-identifying authentication code is a resident registration number of the purchaser or a secret number registered to the mobile communication service provider server by the purchaser.

4. The method for approving electronic payment according to claim 1,
wherein, in the step (c), the certification success code is transmitted under the conditions that:
as a result of inquiring the mobile communication subscriber database by the mobile communication service provider server, it is determined that the mobile terminal number is recorded in the mobile communication subscriber database and a mobile communication charge of the purchaser is not delayed.

5. The method for approving electronic payment according to claim 1,
wherein, in the step (c), the certification success code is transmitted under the conditions that:
as a result of inquiring the mobile communication subscriber database by the mobile communication service provider server, it is determined that the mobile terminal number is recorded in the mobile communication subscriber database, a mobile communication charge of the purchaser is not delayed, and the purchaser mobile terminal is not terminated or suspended.

6. The method for approving electronic payment according to claim 1,
wherein, in the step (c), the certification success code is transmitted under the conditions that:
as a result of inquiring the mobile communication subscriber database by the mobile communication service provider server, it is determined that the mobile terminal number is recorded in the mobile communication subscriber database, a mobile communication charge of the purchaser is not delayed, the purchaser mobile terminal is not terminated or suspended, and the purchaser-identifying authentication code input from the purchaser terminal is identical to a purchaser-identifying authentication code recorded in the mobile communication subscriber database.

7. The method for approving electronic payment according to claim 4,
wherein the mobile communication subscriber database stores a predetermined payment limit capable of being settled by the mobile terminal and a total payment accumulated until now,
wherein, in the step (b), the price information is further transmitted to the mobile communication service provider server, and
wherein, in the step (c), the certification success code is transmitted under the additional condition that as a result of inquiring the mobile communication subscriber database by the mobile communication service provider server, it is determined that a sum of the accumulated total payment and the price is not exceeding the payment limit.

8. The method for approving electronic payment according to claim 1,
wherein, in the step (d), the access to WAP is conducted by means of manipulation of a call button provided on the purchaser mobile terminal.

9. The method for approving electronic payment according to claim 1,
wherein, in the step (a), a member store code of the electronic shopping mall server is further received from the purchaser terminal,
wherein, after the step (d), the method further comprises the step of storing a mobile terminal number of the payment-approved mobile terminal, a payment-approved price, a payment-approved product information, a member store code of the electronic shopping mall server and a payment approval date in a payment approval database.

10. The method for approving electronic payment according to claim 1, further comprising the steps of, after the step (d):
transmitting a payment approval code to the electronic shopping mall server; and
storing a payment-approved price, a payment-approved product information and a payment approval date in a selling information database by the electronic shopping mall server under the condition that the payment approving code is received.

11. The method for approving electronic payment according to claim 2,
wherein, in the step (e), the certification success code is transmitted under the conditions that:
as a result of inquiring the mobile communication subscriber database by the mobile communication service provider server, it is determined that the mobile terminal number is recorded in the mobile communication subscriber database and a mobile communication charge of the purchaser is not delayed.

12. The method for approving electronic payment according to claim 2,
wherein, in the step (e), the certification success code is transmitted under the conditions that:
as a result of inquiring the mobile communication subscriber database by the mobile communication service provider server, it is determined that the mobile terminal number is recorded in the mobile communication subscriber database, a mobile communication charge of the purchaser is not delayed, and the purchaser mobile terminal is not terminated or suspended.

13. The method for approving electronic payment according to claim 2,
wherein, in the step (e), the certification success code is transmitted under the conditions that:
as a result of inquiring the mobile communication subscriber database by the mobile communication service provider server, it is determined that the mobile terminal number is recorded in the mobile communication subscriber database, a mobile communication charge of the purchaser is not delayed, the purchaser mobile terminal is not terminated or suspended, and the purchaser-identifying authentication code input from the purchaser mobile terminal is identical to a purchaser-identifying authentication code recorded in the mobile communication subscriber database.

14. The method for approving electronic payment according to claim 11,
wherein the mobile communication subscriber database stores a predetermined payment limit capable of being settled by the mobile terminal and a total payment accumulated until now,
wherein, in the step (d), the price information is further transmitted to the mobile communication service provider server, and
wherein, in the step (e), the certification success code is transmitted under the additional condition that as a result of inquiring the mobile communication subscriber database by the mobile communication service provider server, it is determined that a sum of the accumulated total payment and the price is not exceeding the payment limit.

15. The method for approving electronic payment according to claim 2,
wherein, in the step (c), the access to WAP is conducted by means of manipulation of a call button provided on the purchaser mobile terminal.

16. The method for approving electronic payment according to claim 2,
wherein, in the step (a), a member store code of the electronic shopping mall server is further received from the purchaser terminal,
wherein, after the step (e), the method further comprises the step of storing a mobile terminal number of the payment-approved mobile terminal, a payment-approved price, a payment-approved product information, a member store code of the electronic shopping mall server and a payment approval date in a payment approval database.

17. The method for approving electronic payment according to claim 2, further comprising the steps of, after the step (e):
transmitting a payment approval code to the electronic shopping mall server; and
storing a payment-approved price, a payment-approved product information and a payment approval date in a selling information database by the electronic shopping mall server under the condition that the payment approving code is received.

18. A system for approving electronic payment using SMS including URL callback, which includes a payment approving server for receiving a request for electronic payment from a purchaser terminal that accesses an electronic shopping mall server and then approving the electronic payment in association with a mobile communication service provider server that operates a mobile communication subscriber database, and also supporting WAP service, wherein the payment approving server executes:
receiving product transaction information including product information and price information of a product to be purchased together with a mobile terminal number of the purchaser and an authentication code for identifying the purchaser from a purchaser terminal that accesses the electronic shopping mall server;
requesting payment certification with transmitting payment certification information including the mobile terminal number and the purchaser-identifying authentication code to the mobile communication service provider server, and then waiting for a response;
transmitting SMS including URL callback for linking WAP access of the payment approving server to the purchaser mobile terminal through the mobile communication service provider server when the mobile communication service provider server transmits a certification success code as a result of inquiring the mobile communication subscriber database with the use of the payment certification information; and
approving the payment under the condition that a mobile terminal transmitted in connection to WAP is identical to the mobile terminal number received in the electronic shopping mall server when the purchaser mobile terminal accesses WAP with the use of the URL callback.

19. A system for approving electronic payment using SMS including URL callback, which includes a payment approving server for receiving a request for electronic payment from a purchaser terminal that accesses an electronic shopping mall server and then approving the electronic payment in association with a mobile communication service provider server that operates a mobile communication subscriber database, and also supporting WAP service, wherein the payment approving server executes:
receiving product transaction information including product information and price information of a product to be purchased together with a mobile terminal number of the purchaser from a purchaser terminal that accesses the electronic shopping mall server;
transmitting SMS including URL callback for linking WAP access of the payment approving server to the purchaser mobile terminal through the mobile communication service provider server;
receiving a purchaser-identifying authentication code from the purchaser mobile terminal under the condition that a mobile terminal number transmitted in connection to WAP is identical to the mobile terminal number received in the electronic shopping mall server when the purchaser mobile terminal accesses WAP with the use of the URL callback;
requesting payment certification with transmitting payment certification information including the mobile terminal number and the purchaser-identifying authentication code to the mobile communication service provider server, and then waiting for a response; and
approving the payment when the mobile communication service provider server transmits a certification success code as a result of inquiring the mobile communication subscriber database with the use of the payment certification information.
